(19) United States
(12) Patent Application Publication
(10) Pub. No.: US 2006/0273038 A1
(43) Pub. Date: Dec. 7, 2006

(54) Chemical cleaning for membranes

(76) Inventors: Murtuza Ali Syed, Burlington (CA); Nicholas William H. Adams, Hamilton (CA); Manwinder Singh, Burlington (CA); Istvan Zsirai, Deak Ferenc (HU)

Correspondence Address: JAECKLE FLEISCHMANN & MUGEL, LLP, 190 Linden Oaks, ROCHESTER, NY, 14625-2812, US

(21) Appl. No.: 11/388,648

(22) Filed: Mar. 24, 2006

Related U.S. Application Data
(60) Provisional application No. 60/687,892, filed on Jun. 7, 2005.

(30) Foreign Application Priority Data
Jun. 2, 2005 (CA) 2,509,017

(51) Int. Cl. B01D 21/01

(52) U.S. Cl. 210/723

(57) ABSTRACT

Membranes, for example immersed polymeric ultrafiltration or microfiltration membranes, are cleaned by contacting them with a chemical cleaner comprising one or more of a gluconate, a hydrosulfite, a metabisulfite or an acid, for example phosphoric acid. The membranes may have been exposed to organic or inorganic foulants, some of which may have resulted from pretreatment involving adding coagulants, for example coagulants containing iron or aluminum, to water to be treated. Methods for treating a waste cleaning solution were described.

This is an application claiming the benefit under 35 USC 119(e) of U.S. Application Ser. No. 60/687,892, filed Jun. 7, 2005. Application Ser. No. 60/687,892 and Canadian Patent Application No. 2,509,017, filed Jun. 2, 2005, are incorporated herein, in their entirety, by this reference to them.

### FIELD OF THE INVENTION

This invention relates to a method for cleaning membranes, for example polymeric membranes, to compositions that may be used to clean membranes and to a method of treating water using membranes having a step of cleaning the membranes.

### BACKGROUND OF THE INVENTION

In U.S. Pat. No. 5,403,479 a method and cleaning system is disclosed for cleaning the outer surface of a fouled microfiltration (MF) or ultrafiltration (UF) semipermeable hollow fiber membrane after its initial stable transmembrane flux has been decreased to an unacceptably low level. The method is specifically applicable to any fiber used to withdraw purified water from dirty water, particularly water containing organic matter including beneficial bacteria and/or undesirable inorganic salts, where the viability of the bacteria population is to be maintained. The membrane is cleaned by flowing a cleaning fluid, preferably a biocidal oxidative electrolyte having an oxidizing anion and an associated cation through the clean, permeate-side of the membrane, at low pressure no more than the bubble pressure breakthrough, usually <300 kPa (30 psig) for a MF or UF fiber. Such low pressure is sufficient to diffuse the electrolyte through both, the pores of the membrane and a fouling film which typically includes a biofilm accumulated on the fibers' outer surface, but not enough electrolyte flows through the membrane to kill numerically more than 20% of the living bacteria in the dirty water. This limitation can be met only if the cleaning period is brief. This period is only long enough to oxidize organic matter within the pores and kill essentially all bacteria in the biofilm. Preferably less than 5% of the bacteria population is decimated. As diffusion takes place, pores are again opened, both in the wall of the fiber and through the biofilm, and when the fibers are returned to normal operation, the restored flux is equal to at least 70% of the initial stable flux.

U.S. patent application Ser. No. 10/461,687, published as 2004-0007525 A1, discloses a method of cleaning ultrafiltration or microfiltration membranes that reduces the rate of decline in the permeability of the membranes so that intensive recovery cleaning is required less frequently. In one aspect, cleaning events using a chemical cleaner are started before the membranes foul significantly and are repeated between 1 and 7 times per week. The product of the concentration of the chemical cleaner expressed as an equivalent concentration of NaOCl and the duration of all cleaning events is between 2,000 minutes·mg/l and 30,000 minutes·solid.mg/l per week. When performed in situ, each cleaning event comprises (a) stopping permeation and any agitation of the membranes, (b) backwashing the membranes with a chemical cleaner in repeated pulses and (c) resuming agitation, if any, and permeation. The pulses last for between 10 seconds and 100 seconds and there is a time between pulses between 50 seconds and 6 minutes. Each cleaning event typically involves between 5 and 20 pulses. In another aspect, cleaning events using a pulsed backwash of heated water are similarly started before the membranes foul significantly and are repeated between twice a day and once every two days.

U.S. Pat. No. 5,403,479 and U.S. patent application Ser. No. 10/461,687 are incorporated herein in their entirety by this reference to them.

### SUMMARY OF THE INVENTION

The following summary is intended to introduce the reader to the invention but not to define it. The invention may reside in any combination of one or more apparatus features, composition elements or process steps found in any part of this document. An object of the invention is to improve on, or at least provide a useful alternative to the prior art. Other alternative objects of the invention include providing a process for cleaning membranes, for example cleaning membranes with a chemical cleaner, providing a composition for cleaning membranes and providing a process for treating water using membranes.

In one aspect, the invention provides a composition including any soluble gluconate, for example sodium gluconate. In another aspect, the invention provides a composition comprising a hydrosulfite, alternately called a dithionite and being generally of the formula X₂S₂O₄, for example sodium hydrosulfite or potassium hydrosulfite, and any soluble gluconate, for example sodium gluconate or potassium gluconate. In another aspect, the invention provides a composition comprising phosphoric acid. In another aspect, the invention provides a composition comprising sodium metabisulfite and phosphoric acid. The composition described above may have the stated chemicals dissolved into a solvent, for example water, at doses effective to clean membranes, for example membranes fouled with inorganic foulants, coagulants, Fe, Al or organic foulants.

In another aspect, the invention provides a method of cleaning membranes using a cleaner, for example a cleaner according to any of the compositions described above. The membranes may be, for example, polymeric membranes with pore sizes in the microfiltration or ultrafiltration ranges. The membranes may be fouled, for example and in whole or in part, by their being exposed to inorganic foulants, coagulants, Fe or Al compounds, or organic foulants in water being treated. Those compounds may exist in the water before treatment or have been added during the treatment process, for example in the form of FeCl₃ or aluminum sulfate used as a coagulant. These coagulants may be used in water filtration plants producing process or potable water, or wastewater treatment plants as a means to condition the mixed liquor or sludge. The cleaning chemical may be applied to the membranes frequently, for example according to a maintenance cleaning procedure that increases permeability by 10% or less or is performed once a week or more frequently, or infrequently, for example according to a recovery cleaning procedure that increases membrane permeability by 20% or more or is performed once every two weeks or less frequently. The chemical cleaner may be applied to the membranes by a variety of techniques such as soaking with the retentate side exposed to a volume of the cleaner, permeating the cleaner through the membranes, backwashing the cleaner through the membranes, recirculating cleaner through the membranes either in the permeating or backwashing direction, pulsing the cleaner through the membranes in either the permeating or backwashing direction, alternately flowing fresh cleaner through the membranes and purging stale cleaner from the membranes either in the same or a reversed direction, or other methods.

In another aspect, the invention provides a composition comprising phosphoric acid and any soluble gluconate, for example sodium gluconate or potassium gluconate. In other aspects, the invention provides each and every permutation and combination of one or more chemicals chosen from the set of: any gluconate; sodium gluconate; potassium gluconate; any metabisulfite (alternately called a bisulfite, disulfite or having a formula of XHSO₃); sodium bisulfite; potassium bisulfite; phosphoric acid; citric acid; oxalic acid; an enhancing agent; sodium citrate; ammonium citrate; a chelating agent; HEDTA [N-(2-hydroeyethyl)ethylene diamine triacetic acid]; EDTA; Na₄EDTA; EDDS; and, triethanol amine.

In another aspect, the invention provides a membrane treatment process comprising steps of treating water by adding a pretreatment chemical including an inorganic chemical or a coagulant, for example adding a chemical containing Fe or Al, treating the water with a membrane, for example a filtering polymeric membrane, and cleaning the membrane with a cleaner, for example a cleaner containing any of the compositions mentioned above.

### BRIEF DESCRIPTION OF THE DRAWINGS

Embodiments of the invention will be described below with reference to the following Figures:

FIGS. 1 to 5 show the results of cleaning methods according to the invention using compositions according to the invention.

### DETAILED DESCRIPTION OF EXEMPLARY EMBODIMENTS

The following description describes embodiments of the invention to provide examples of the invention. The invention is not limited to these examples.

Membrane treatment systems are described generally in U.S. Pat. No. 5,639,373, now reissued as RE37,549, and U.S. Pat. No. 6,325,928. A membrane treatment system involving the addition of a coagulant is described in U.S. Pat. No. 6,027,649. U.S. Pat. Nos. 5,639,373; RE37,549; 6,325,928; and, 6,027,649 are incorporated herein in their entirety by this reference to them.

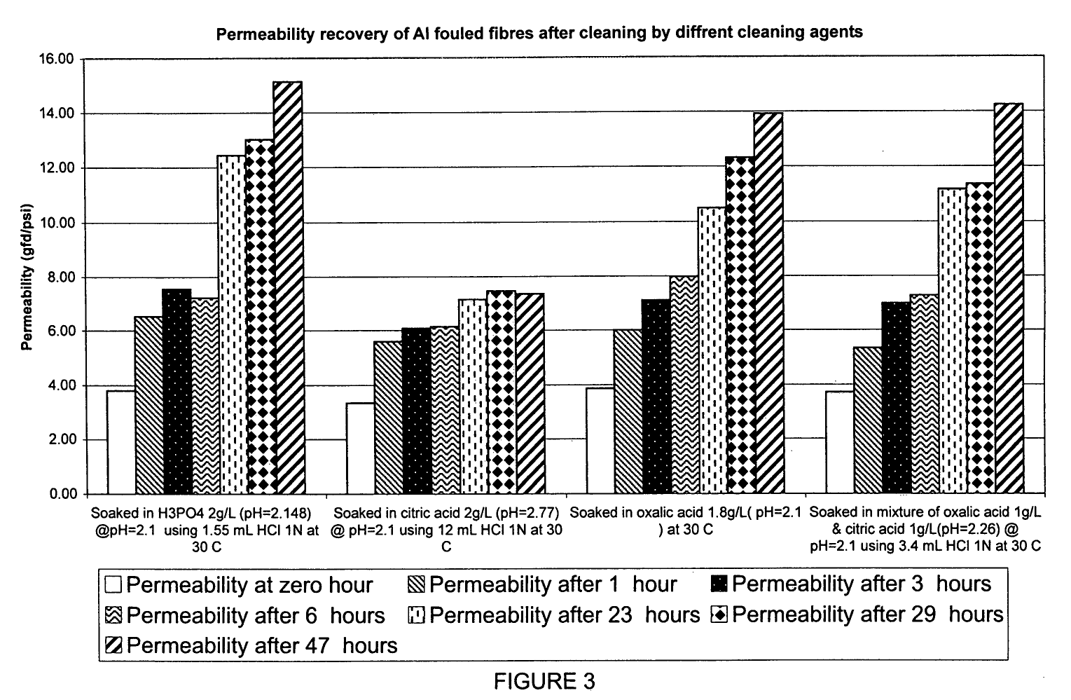

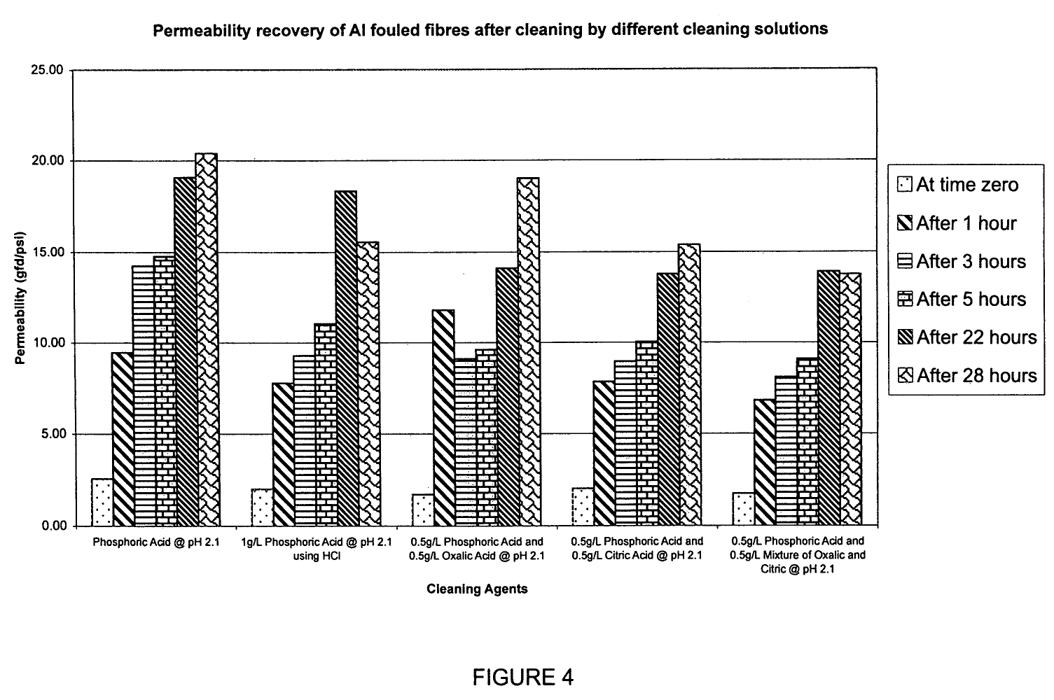

Immersed, suction driven, polymeric membranes with pores in the ultrafiltration or microfiltration range may be used to treat water. The treatment process may involve adding aluminum sulfite or another aluminum based coagulant in a pretreatment step prior to filtering the water with the membranes. The pretreatment step may be performed directly upstream of the membranes or otherwise such that the membranes are exposed to the coagulant. Membranes used in such a process may become fouled with aluminum. The fouling may be heavy, particularly if there has been an overdose of the coagulant or the coagulant has been used outside of an optimal pH range. Such fouled membranes may be cleaned by contacting them with phosphoric acid. For example, a solution of phosphoric acid in water may be prepared with a pH of 2.5 or less. This may require adding 0.3-2.5 g/L of phosphoric acid to a supply of water which may be, for example, drinking water, process water, feed water or permeate. However, the amount of phosphoric acid required may be more or less than the amounts mentioned above depending on the alkalinity of the water being treated. Other acids, such as HCl, may be added to the solution to assist in reducing the pH or provide cleaning of other foulants. The membranes may be contacted with this solution by soaking the membranes in the solution, optionally while also circulating solution through the membranes by backwash or permeation in a loop, by a purge and refresh process as described in U.S. Provisional Application No. 60/673,763 filed Apr. 22, 2005 which is hereby incorporated in its entirety by this reference to it, by backwashing or permeating the solution through the membranes, or other methods. FIG. 4 shows the result of cleaning Al fouled ZeeWeed™ membranes with phosphoric acid while FIG. 3 shows results of cleaning similarly fouled fibers with a solution of phosphoric acid and HCl.

Cleaning membranes with phosphoric acid produces a spent cleaning solution with a high phosphorous concentration. This phosphorus may be precipitated from the spent cleaning solution, allowed to settle out and removed from the spent cleaning solution. The phosphorous may be precipitated by adding lime or lime with an iron or aluminum based coagulant, for example aluminum sulfite or ferric chloride (FeCl₃) to the spent chemical solution. The chemicals mentioned above may be added in sufficient amounts such that, upon removal of settled precipitates, for example by clarification, decanting, filtration, hydrocyclone or other methods, the phosphorous concentration in the waste stream is reduced to 5 mg/L or less.

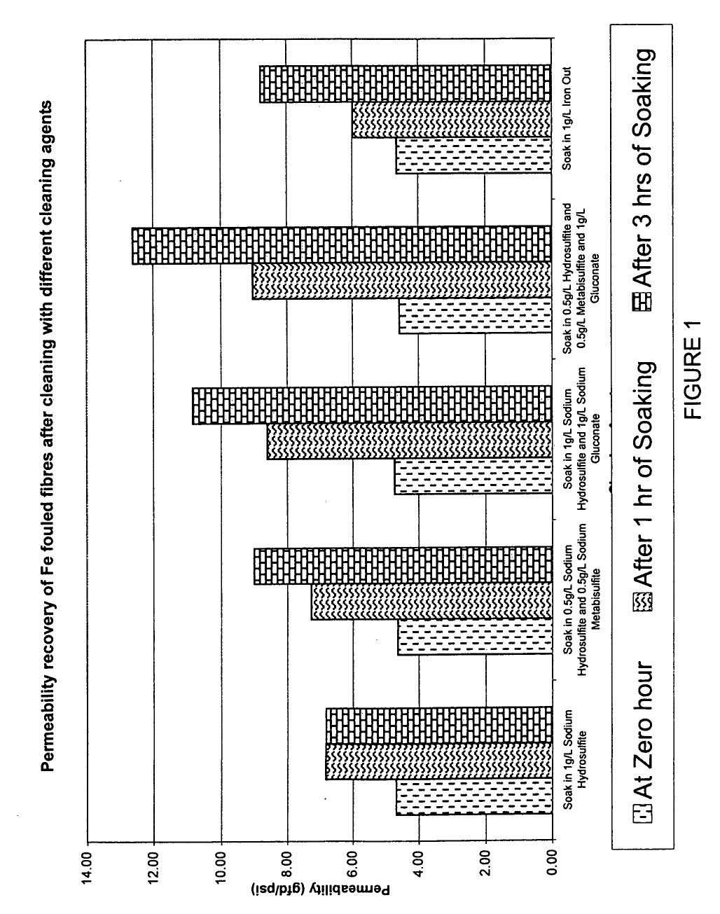

Membranes as described above may also be used in systems for processes as described above with FeCl₃ used as a coagulant in a pretreatment step. This can lead to iron fouling of the membranes. Such membranes may be cleaned with a mixture comprising a sulfite and a gluconate, for example sodium hydrosulfite and sodium gluconate. These chemicals may be mixed in water to form a solution that may be contacted to membranes by any of the methods described above. Results of tests in which iron fouled ZeeWeed™ hollow fiber polymeric membranes made by Zenon Environmental Inc. were cleaned by soaking in various cleaners are shown in FIG. 1. As indicated in FIG. 1, adding sodium gluconate to a cleaner containing one or more sulfite reducing agents, for example between 0.5 and 2 g/L of sulfite containing compounds in water, increases the efficacy of the cleaner. The sodium gluconate may be added to water at, for example, between 0.5 g/L to 2 g/L. The sodium gluconate may act as a complexing agent.

When using sulfites, a waste cleaning solution may be created with COD. For example, sodium metabisulfite has a COD of 165 mg O₂/g and sodium hydrosulfite also has COD. The cleaning solution may therefore tend to scavenge oxygen and to create a disposal concern in some plants. To counter this problem, waste cleaning solution may be aerated, for example by placing the waste cleaning solution in an aeration tank before disposal. Sodium gluconate is highly biodegradable and so does not provide a significant disposal problem although it may be biodegraded before disposal if desired.

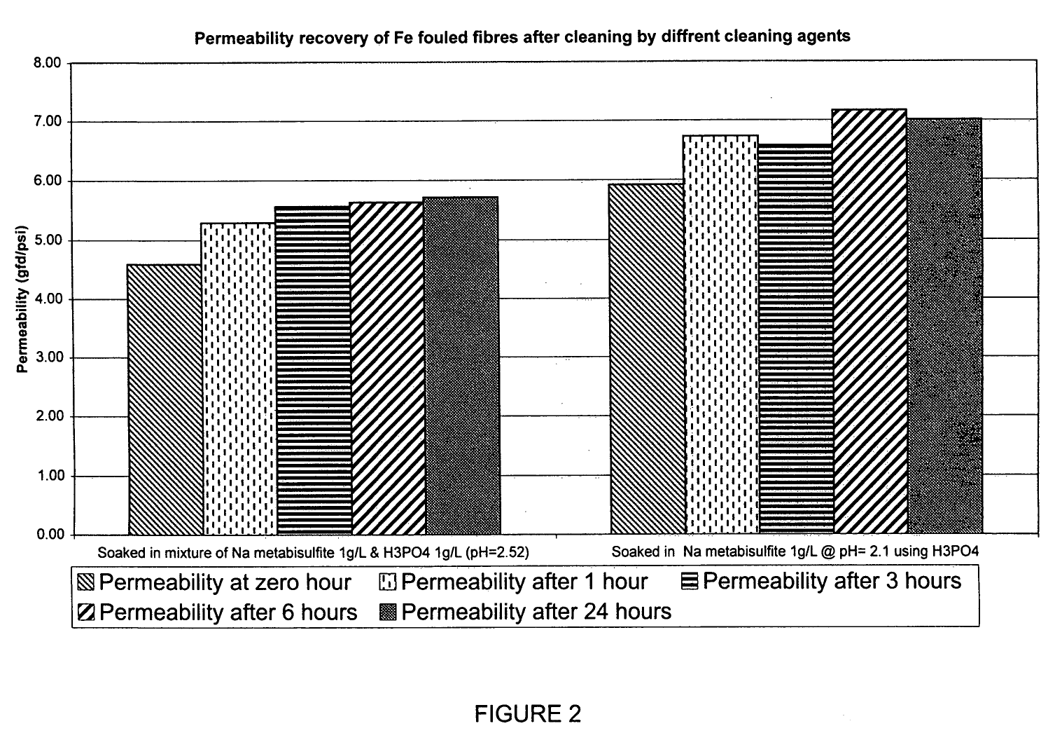

Membranes may also be cleaned with a mixture of a sulfite reducing agent, for example, sodium metabisulfite or sodium hydrosulfite, and phosphoric acid. Cleaning with such a mixture may be used when the membranes are fouled with iron, aluminum or both. Cleaning with such a mixture may produce SO₂. Results of some tests of iron fouled ZeeWeed™ membranes using cleaners having sodium metabisulfite and phosphoric acid are provided in FIG. 2. Sodium hydrosulfite or other sulfites may be used in place of the sodium metabisulfite.

Other acids may be used in place of or in combination with phosphoric acid in the compositions or processes described above using phosphoric acid. The other acids may include, or example, citric acid or oxalic acid. FIGS. 3 and 4 show the results of cleaning polymeric hollow fiber membrane fibers taken from a ZeeWeed™ module made by Zenon Environmental Inc. used in a process with aluminum sulfite used as a coagulant in a pretreatment step. The fibers were cleaned by soaking them in various cleaning chemicals for various amounts of time. As indicated in FIGS. 3 and 4, a solution of phosphoric acid alone produced the largest increase in permeability, suggesting that phosphoric acid is a strong complexing agent for aluminum. In comparison, while citric acid alone produced some increase in permeability, it was inadequate for cleaning the fibers tested, which were heavily fouled. However, a solution of oxalic acid was effective, as was a solution of oxalic acid and citric acid. These other acids produce less phosphorous in the waste cleaning chemical stream. Accordingly, membranes can be cleaned with, for example, oxalic acid or a mixture comprising oxalic acid and citric acid. Further, acids or mixtures of two or more acids, for example citric acid, oxalic acid, or a mixture of citric acid and oxalic acids, may be used with phosphoric acid to produce a chemical cleaner benefiting to some extend from the efficacy of phosphoric acid but producing less phosphorous in the waste cleaning chemical. Increases in permeability resulting from soaking of fouled fibers in phosphoric acid and mixtures of phosphoric acid and other acids is shown in FIG. 4. As indicated in FIG. 4, these mixtures, while using less phosphoric acid, produced satisfactory results. The effectiveness of these mixtures was less than for phosphoric acid alone but sufficient to make the cleaners useful and possibly preferred depending on the extent of fouling and regulations regarding phosphorous discharge in a particular plant.

A membrane system may also be cleaned using different chemicals at different times. For example, for frequent maintenance cleaning, membranes may be cleaned with a cleaner having one or more of oxalic acid, phosphoric acid, or citric acid. For example, the maintenance cleaning may be done with oxalic acid, phosphoric acid, a mixture of oxalic and phosphoric acid, or a mixture of oxalic, phosphoric and citric acid, optionally with other acids, for example HCl, which may assist in reducing the pH of the cleaner or in removing other foulants. For recovery cleaning, the membranes may be cleaned with a mixture of a sulfite, for example sodium hydrosulfite, and a gluconate, for example sodium or potassium gluconate. Multiple sulfites may also be used, for example a mixture of sodium hydrosulfite, sodium metabisulfite and sodium gluconate. Enhancing agents, for example sodium citrate or ammonium citrate, may also be added. Chelating agents, for example HEDTA[N-(2-hydroeyethyl) ethylene diamine triacetic acid], EDTA, Na₄EDTA, EDDS, or triethanolamine, may also be added.

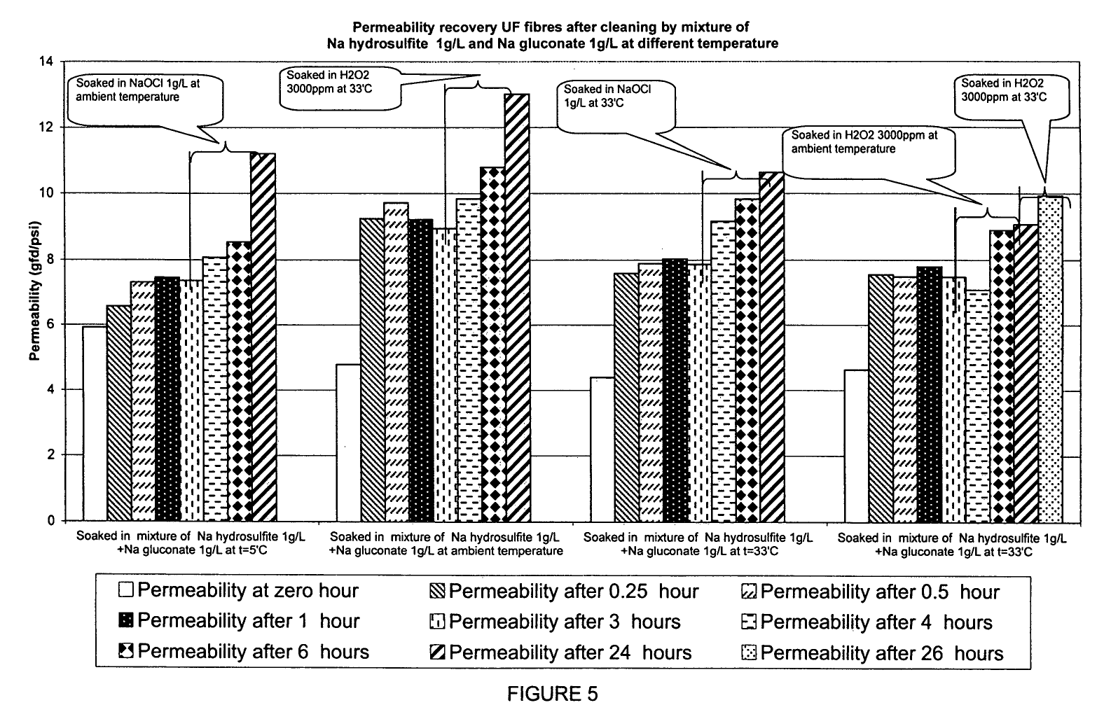

A membrane system may also be cleaned using different chemical cleaners in sequence. For example, FIG. 5 shows the results of various chemical cleaners contacted, by soaking, against UF hollow fiber polymeric membranes (ZeeWeed™ 1000 membranes) fouled primarily by organic foulants. The membranes were first cleaned by soaking in solutions of sodium hydrosulfite and sodium gluconate. These treatments resulted in a partial increase in permeability. The membranes were then soaked in a solution of NaOCl or S₂O₂ which resulted in further increases in permeability.

1. A composition for cleaning membranes comprising any combination of one or more of a hydrosulfite, a gluconate, a metabisulfite or phosphoric acid.

2. A composition according to claim 1 comprising any two or more of a hydrosulfite, a gluconate, a metabisulfite or phosphoric acid.

3. A composition according to claim 1 comprising a hydrosulfite and a gluconate.

4. A composition according to claim 1 comprising a metabisulfite and phosphoric acid.

5. A composition according to claim 1 comprising phosphoric acid.

6. A process for cleaning membranes comprising the steps of contacting the membranes with a composition for cleaning membranes comprising any combination of one or more of a hydrosulfite, a gluconate, a metabisulfite or phosphoric acid.

7. A process for cleaning membranes according to claim 6 comprising the steps of contacting the membranes with a composition comprising any two or more of a hydrosulfite, a gluconate, a metabisulfite or phosphoric acid.

8. A process for cleaning membranes according to claim 6 comprising the steps of contacting the membranes with a composition comprising a hydrosulfite and a gluconate.

9. A process for cleaning membranes according to claim 6 comprising the steps of contacting the membranes with a composition comprising a metabisulfite and phosphoric acid.

10. A process for cleaning membranes according to claim 6 comprising the steps of contacting the membranes with a composition comprising phosphoric acid.

11. A process for treating water comprising the steps of adding a coagulant containing Fe or Al to the water, filtering the water through a membrane and then cleaning the membrane by contacting it with a composition for cleaning membranes comprising any combination of one or more of a hydrosulfite, a gluconate, a metabisulfite or phosphoric acid.

12. A process for treating water according to claim 11 comprising the steps of adding a coagulant containing Fe or Al to the water, filtering the water through a membrane and then cleaning the membrane by contacting it with a composition comprising any two or more of a hydrosulfite, a gluconate, a metabisulfite or phosphoric acid.

13. A process for treating water according to claim 11 comprising the steps of adding a coagulant containing Fe or Al to the water, filtering the water through a membrane and then cleaning the membrane by contacting it with a composition comprising a hydrosulfite and a gluconate.

14. A process for treating water according to claim 11 comprising the steps of adding a coagulant containing Fe or Al to the water, filtering the water through a membrane and then cleaning the membrane by contacting it with a composition comprising a metabisulfite and phosphoric acid.

15. A process for treating water according to claim 11 comprising the steps of adding a coagulant containing Fe or Al to the water, filtering the water through a membrane and then cleaning the membrane by contacting it with a composition comprising phosphoric acid.

16. The process of claim 6 further comprising a step of treating the composition after it has been contacted with the membranes.

17. The process of claim 11 further comprising a step of treating the composition after it has been contacted with the membranes.

18. A process for cleaning membranes comprising a step of contacting the membranes with a composition comprising a hydrosulfite and a gluconate and a step of contacting the membranes with NaOCl or S₂O₂.

19. The process of claim 18 comprising a step of contacting the membranes with NaOCl.

20. The process of claim 18 comprising a step of contacting the membranes with S₂O₂.
